(19) United States
(12) Patent Application Publication
(10) Pub. No.: US 2025/0297700 A1
(43) Pub. Date: Sep. 25, 2025

(54) PIPE JOINT UNIT

(71) Applicant: TOYODA GOSEI CO., LTD., Kiyosu-shi (JP)

(72) Inventors: Kento UCHIYAMA, Kiyosu-shi (JP); Kenta KUWAYAMA, Kiyosu-shi (JP); Masayuki MIYAMURA, Kiyosu-shi (JP)

(21) Appl. No.: 19/058,613

(22) Filed: Feb. 20, 2025

(30) Foreign Application Priority Data
Mar. 22, 2024 (JP) 2024-047371

(51) Int. Cl. F16L 41/08; F16L 41/02

(52) U.S. Cl. CPC F16L 41/08; F16L 41/021

(57) ABSTRACT

A pipe joint unit includes: a first joint member having a tubular pipe part penetrating a case through-hole, and a flange part extending radially outward at a position in an extending direction of the pipe part; and a second joint member that has a plate-shaped plate part provided with a plate through-hole and opposing the flange part with a case wall therebetween, and that is rotatable relative to the first joint member. The first and second joint members have a pipe mounting structure that fixes the pipe part to the case wall with a relative distance, in the extending direction between the flange part and the plate part, reduced by the first and second joint members performing relative rotation in a circumferential direction of the pipe part in a state where the flange part and the plate part oppose each other with the case wall therebetween in the extending direction.

### TECHNICAL FIELD

The present disclosure relates to a pipe joint unit that fixes a pipe part to a case wall of a battery pack installed in an electric vehicle or the like, for example.

### BACKGROUND ART

Conventionally, a battery pack installed in an automobile such as an electric vehicle has been known (e.g., JP2023-526828 (A)). A battery pack is obtained by connecting a plurality of single cells of a secondary battery such as a lithium ion battery, a lithium polymer battery, a nickel-cadmium battery, a nickel-metal hydride battery, or a nickel-zinc battery in series or in parallel, and then accommodating a resultant battery module in a case. A battery installed in an automobile is placed in a harsh use environment and exposed to high-temperature outside air. In addition, in such a case where the battery is used as a power generation source for the automobile, charging and discharging are repeated, and thus, the temperature of the battery tends to be high.

Therefore, the aforementioned battery pack according to JP2023-526828 (A) is provided with a pipe for supplying a coolant into the case from outside and cooling the battery module through heat exchange. The pipe includes: an inner pipe routed in the case accommodating the battery module; and a pipe joint unit mounted to the wall of the case and connecting the inner pipe and an outer pipe on the supply source side to each other.

The pipe joint unit has a pipe part extending in a tubular shape, and a flange part extending radially outward from an outer periphery portion of the pipe part. The wall of the case is provided with a case through-hole into which the pipe part of the pipe joint unit is inserted. The pipe joint unit is disposed so as to oppose the case wall via a seal member for ensuring the sealing performance at the case through-hole with respect to the flange part in a state where the pipe part is inserted in the case through-hole. The flange part and the case wall each have a plurality of bolt holes formed therein. Bolts are inserted into the bolt holes in the flange part and the bolt holes in the case wall, and fastened with nuts, whereby the pipe joint unit is mounted and fixed to the case wall in a state where the sealing performance is ensured by the seal member.

### SUMMARY OF INVENTION

### Technical Problem

However, the technique in which the pipe joint unit and the case are fixed together by using bolts as described above requires use of bolts provided separately from the flange part and the case wall to be connected. Therefore, assembling the pipe joint unit to the case wall requires work, and in addition, bolts need to be prepared. Therefore, man-hour for assembling the pipe joint unit and the case wall increases and the manufacturing cost increases.

The present disclosure has been made in view of the above. An object of the present disclosure is to provide a pipe joint unit that realizes mounting and fixation thereof to a case wall in a simple manner and at low cost.

### Solution to Problem

An aspect of the present disclosure is a pipe joint unit including: a first joint member having a pipe part in a tubular shape extending through a case through-hole provided in a case wall, and a flange part integrated with the pipe part and extending radially outward at a position in an extending direction of the pipe part; and a second joint member having a plate part in a plate shape, the plate part being provided with a plate through-hole that the pipe part penetrates and opposing the flange part with the case wall interposed therebetween, the second joint member being capable of performing relative rotation with respect to the first joint member. The first joint member and the second joint member have a pipe mounting structure configured to fix the pipe part to the case wall with a relative distance, in the extending direction between the flange part and the plate part, reduced by the first joint member and the second joint member performing relative rotation in a first direction of a circumferential direction of the pipe part in a state where the flange part and the plate part oppose each other with the case wall interposed therebetween in the extending direction.

With this configuration, mounting and fixing of the pipe joint unit to the case wall are realized in a simple manner and at low cost.

### BRIEF DESCRIPTION OF DRAWINGS

FIG. 1 is a perspective view of a battery pack including a pipe joint unit according to an embodiment of the present disclosure;

FIG. 2 is a perspective view of the pipe joint unit of the present embodiment, viewed from the inner side of a case (as for the case, only a case wall being a part thereof is shown);

FIG. 3 is a cross-sectional view of the pipe joint unit of the present embodiment;

FIG. 4 is an exploded view (the case wall included) of the pipe joint unit of the present embodiment;

FIG. 5 is a perspective view of a first joint member included in the pipe joint unit of the present embodiment, viewed from the outer side of the case (as for the case, only the case wall being a part thereof is shown);

FIG. 6 is a front view of the first joint member included in the pipe joint unit of the present embodiment;

FIG. 7 is an enlarged view of the portion surrounded by a dashed-dotted line shown in FIG. 6;

FIG. 8 is a perspective view of the first joint member included in the pipe joint unit of the present embodiment;

FIG. 9 is an external view of a second joint member included in the pipe joint unit of the present embodiment; and

FIG. 10 is a cross-sectional view along X-X shown in FIG. 9.

### DESCRIPTION OF EMBODIMENTS

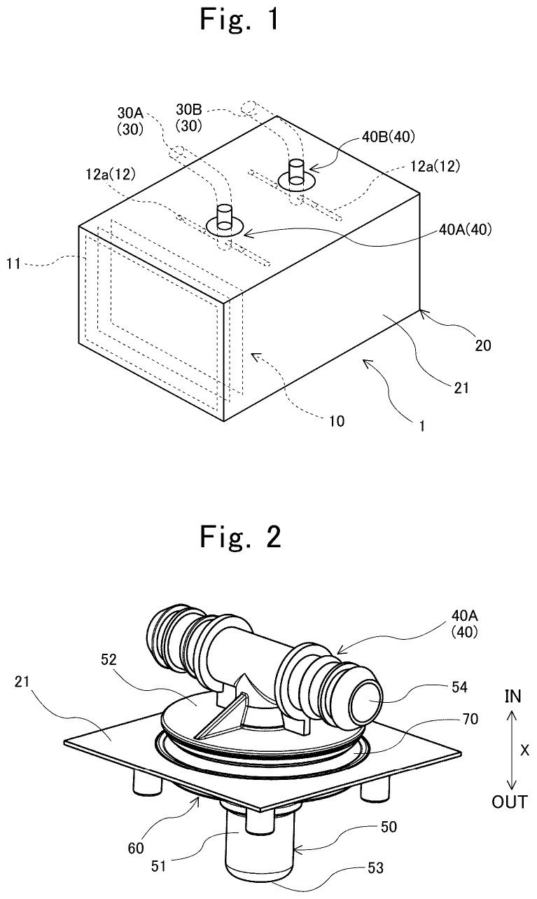

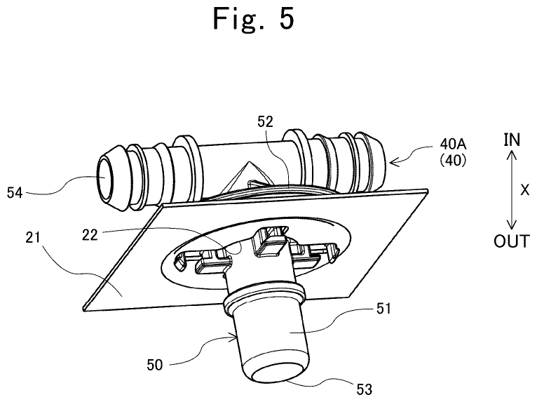

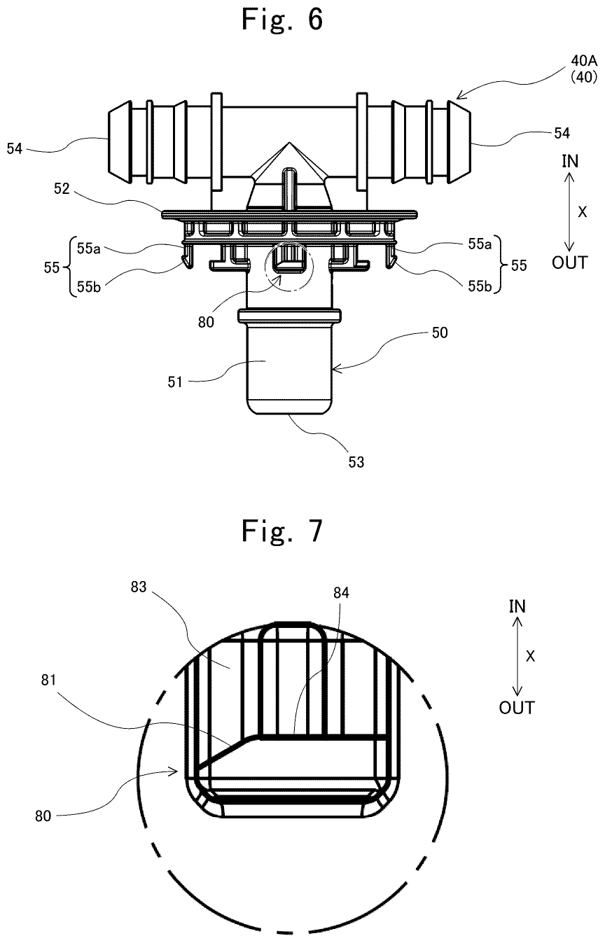

Hereinafter, with reference to FIG. 1 to FIG. 10, a specific embodiment and modification of a pipe joint unit according to the present disclosure will be described. In the present embodiment and modification, “in” and “out” are defined based on a case 20, and “in” means the inner side of the case 20 and “out” means the outer side of the case 20.

A pipe joint unit 40 of the present embodiment is a pipe connection structure applied to a battery pack 1 installed in an automobile or household electric power storage equipment. The automobile in which the battery pack 1 is installed is an electric vehicle, a hybrid vehicle, a plug-in hybrid vehicle, or the like, for example. When the battery pack 1 is installed in an automobile, the battery pack 1 that includes a battery to serve as a power source during travel of the automobile is suitable.

As shown in FIG. 1, the battery pack 1 includes a battery module 10 and the case 20, and further includes the pipe joint unit 40.

The battery module 10 is a device that generates electric power. The battery module 10 has a battery cell 11. The battery cell 11 is the minimum unit forming a battery. The battery cell 11 is formed as a laminate type, a columnar type, or a prism type, for example. The battery cell 11 is a secondary battery such as a lithium ion battery cell, a nickel-metal hydride battery cell, a nickel-cadmium battery cell, or an all-solid-state battery cell. The battery module 10 is a module obtained by connecting a plurality of the battery cells 11 in series or in parallel.

The battery module 10 is accommodated in the case 20. The case 20 is a box-shaped member surrounded by a case wall 21, and is formed in a rectangular parallelepiped shape, for example. The case 20 is made of metal such as aluminum, for example. Preferably, the case wall 21 is formed in a flat plate shape. The case wall 21 is provided with a case through-hole 22. The case through-hole 22 is formed in a shape into which a pipe part 51 of the pipe joint unit 40 is insertable.

In addition, the battery module 10 has an inner pipe unit 12. The inner pipe unit 12 is a pipe unit for cooling the battery cells 11. The inner pipe unit 12 has a cooling path 12a in communication with an inlet into which a coolant flows and an outlet from which the coolant flows out. Preferably, the cooling path 12a of the inner pipe unit 12 is evenly routed in the case 20, and preferably, the battery cells 11 in the case 20 are uniformly cooled by the coolant flowing in the cooling path 12a.

The inner pipe unit 12 is coupled to an outer pipe unit 30 via the pipe joint unit 40 on the inlet side, and is coupled to an outer pipe unit 30 via the pipe joint unit 40 on the outlet side. Hereinafter, as appropriate, the pipe joint unit 40 on the inlet side will be simply referred to as “inlet-side pipe unit 40A” and the pipe joint unit 40 on the outlet side will be simply referred to as “outlet-side pipe unit 40B”. In addition, the outer pipe unit 30 on the inlet side will be referred to as “inlet-side outer pipe unit 30A”, and the outer pipe unit 30 on the outlet side will be referred to as “outlet-side outer pipe unit 30B. The coolant circulates in the order of the inlet-side outer pipe unit 30A→the inlet-side pipe unit 40A→the cooling path 12a of the inner pipe unit 12→the outlet-side pipe unit 40B→the outlet-side outer pipe unit 30B.

Each pipe joint unit 40 is a connection unit that connects the outer pipe unit 30 and the inner pipe unit 12. Each pipe joint unit 40 is mounted and fixed to the case wall 21 of the case 20. Each pipe joint unit 40 is formed and disposed so as to sandwich the case wall 21 at the place where the case through-hole 22 is provided in the case wall 21.

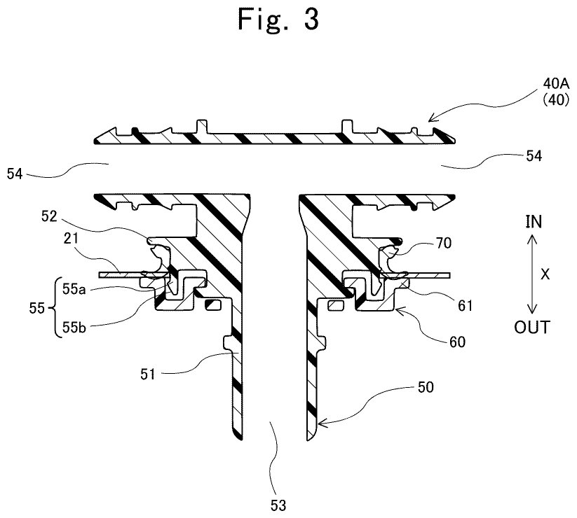

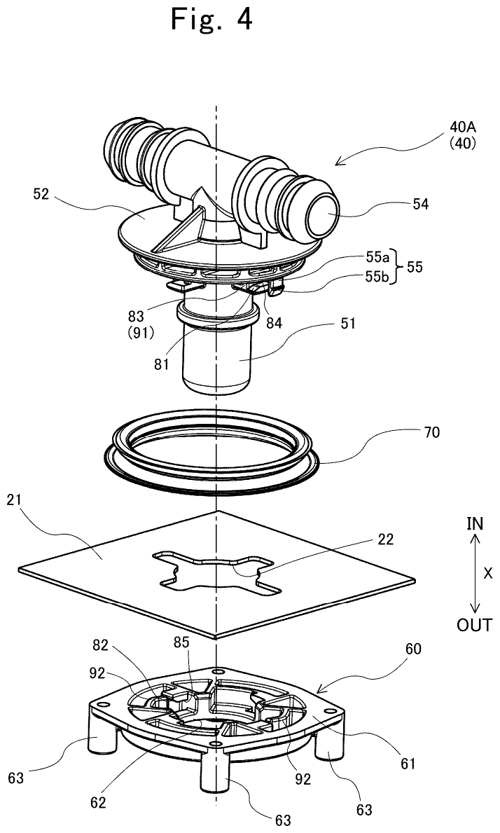

As shown in FIG. 2, FIG. 3, and FIG. 4, the pipe joint unit 40 includes a first joint member 50, a second joint member 60, and a seal member 70. The first joint member 50, the second joint member 60, and the seal member 70 are implemented as components separate from each other. The pipe joint unit 40 is mounted and fixed to the case wall 21 by the first joint member 50 and the second joint member 60 being assembled to each other.

The first joint member 50 is molded with resin, for example. The material of the first joint member 50 is a thermoplastic resin such as polyphenylene sulfide (PPS) or polypropylene (PP), for example. The first joint member 50 has the pipe part 51 and a flange part 52. The pipe part 51 is a portion having a hollow tubular shape through which a fluid flows. The pipe part 51 extends so as to penetrate the case through-hole 22 in the case wall 21. The pipe part 51 is formed such that a part or the entirety thereof has a straight shape or a curved shape.

The pipe part 51 is provided with a flow-in part 53 into which the fluid flows, and is provided with a flow-out part 54 through which the fluid flows out. The fluid that flows through the pipe part 51 may be any fluid that cools the battery cells 11 in the case 20, and may be water, for example.

In the inlet-side pipe unit 40A, the flow-in part 53 of the pipe part 51 is disposed on the outer side with respect to the case wall 21, and the flow-out part 54 is disposed on the inner side with respect to the case wall 21. In the outlet-side pipe unit 40B, the flow-in part 53 of the pipe part 51 is disposed on the inner side with respect to the case wall 21, and the flow-out part 54 is disposed on the outer side with respect to the case wall 21. The inlet-side pipe unit 40A and the outlet-side pipe unit 40B may be formed using common members with each other, and between the inlet-side pipe unit 40A and the outlet-side pipe unit 40B, components disposed on the inner side of the case wall 21 and components disposed on the outer side of the case wall 21 may be reversed from each other, and specifically, the flow-in part 53 and the flow-out part 54 may be reversed from each other.

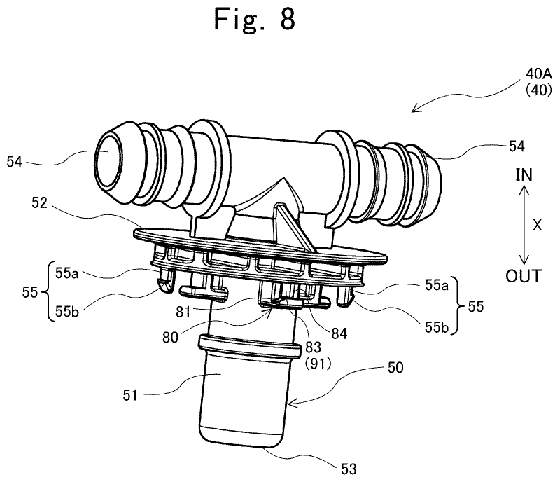

As shown in FIG. 1 to FIG. 6, and FIG. 8, the pipe part 51 of the inlet-side pipe unit 40A and the pipe part 51 of the outlet-side pipe unit 40B may each be formed into two or more branches on the inner side with respect to the case wall 21, and the flow-out part 54 of the inlet-side pipe unit 40A and the flow-in part 53 of the outlet-side pipe unit 40B may each be provided at two or more places.

In the following, the flow-out part 54 of the inlet-side pipe unit 40A and the flow-in part 53 of the outlet-side pipe unit 40B are each assumed to be provided at two places, and the flow-in part 53 of the inlet-side pipe unit 40A and the flow-out part 54 of the outlet-side pipe unit 40B are each assumed to be provided at one place. That is, the pipe part 51 of the inlet-side pipe unit 40A and the pipe part 51 of the outlet-side pipe unit 40B are each assumed to be formed in a T-shape. Further, in the following, except for the relationship between flow-in and flow-out of the fluid, the inlet-side pipe unit 40A will be described as a representative of the pipe joint unit 40.

The flange part 52 is a plate-shaped portion extending radially outward from the pipe part 51. The flange part 52 is integrated with the pipe part 51. The pipe part 51 and the flange part 52 are integrated with each other through integral molding of resin, or are integrated with each other by assembling and fixing of a component in which the pipe part 51 is formed and a component in which the flange part 52 is formed, for example.

The flange part 52 is provided over the entire circumference, at a position in an extending direction X, of an outer periphery portion of the pipe part 51 (specifically, on the side to be inserted into the case through-hole 22 in the case wall 21; the flow-in part 53 side in the inlet-side pipe unit 40A). The flange part 52 is formed in a circular shape or a quadrate shape, for example. The flange part 52 is disposed such that, on the inner side of the case 20, the outer surface of the flange part 52 opposes the inner surface of the case wall 21 via the seal member 70. The first joint member 50 is disposed such that: the pipe part 51 is inserted from the inner side of the case 20 into the case through-hole 22 in the case wall 21; and the flange part 52 opposes the inner surface of the case wall 21.

The flange part 52 has a hook part 55. The hook part 55 is a portion that hooks onto the outer surface of the case wall 21 after the pipe joint unit 40 has been mounted to the case wall 21. The hook part 55 is provided at a plurality of places about the axis center in the flange part 52, and is preferably provided at symmetrical places with respect to the axis center, for example. The hook part 55 has a deflection part 55a and a claw part 55b.

The deflection part 55a is a portion formed so as to protrude outward from the outer surface of the flange part 52 and be able to undergo deflection deformation in the direction (specifically, the radial direction) that crosses the protruding direction (i.e., inward-outward direction of the flange part 52). The claw part 55b is a portion protruding in the radial direction at a leading end portion of the deflection part 55a. The claw part 55b is formed in a tapered shape such that the protruding amount in the radial direction becomes large from the leading end side toward the root side of the deflection part 55a. The claw part 55b may be formed so as to be able to undergo deflection deformation in the circumferential direction.

The case through-hole 22 in the case wall 21 is formed in a shape (e.g., key-shaped cross as shown in FIG. 4) into which the flow-in part 53 side of the pipe part 51 is insertable and the hook part 55 is insertable. The case through-hole 22 is formed such that, in a state where the pipe part 51 and the hook part 55 are inserted, rotation of the first joint member 50 with respect to the case wall 21 is restricted and the first joint member 50 is positioned with respect to the case wall 21.

During mounting and fixing of the pipe joint unit 40 to the case wall 21, first, the first joint member 50 including the pipe part 51 and the flange part 52 is disposed in the case 20, and the flow-in part 53 side of the pipe part 51 and the hook part 55 are inserted into the case through-hole 22 in the case wall 21 and disposed so as to protrude from the inner side to the outer side of the case wall 21. During the process in which the hook part 55 is inserted into the case through-hole 22 in the case wall 21, the deflection part 55a is pressed by a peripheral edge portion of the case through-hole 22 in the case wall 21 and undergoes deflection deformation, and then, after the claw part 55b has passed through the case through-hole 22, the pressing force from the peripheral edge portion of the case through-hole 22 is released, and the deflection part 55a returns to the original shape thereof.

Therefore, even if a force to pull out the first joint member 50 from the outer side to the inner side of the case 20 acts on the first joint member 50 after the claw part 55b of the hook part 55 has passed through the case through-hole 22, the claw part 55b hooks on the outer surface of the case wall 21, and thus, the first joint member 50 is prevented from being pulled out to the inner side of the case 20.

The second joint member 60 is molded with resin, for example. The material of the second joint member 60 is a thermoplastic resin such as polyphenylene sulfide (PPS) or polypropylene (PP), for example. The second joint member 60 is capable of performing relative rotation with respect to the first joint member 50. The second joint member 60 has a plate part 61. As shown in FIG. 4, the plate part 61 is a plate-shaped portion that opposes the flange part 52 of the first joint member 50 with the case wall 21 interposed therebetween, during the mounting and fixing work of the pipe joint unit 40 to the case wall 21, and after the work. The plate part 61 is formed in a quadrate shape or a circular shape, for example. The plate part 61 is molded with resin, for example. The plate part 61 is disposed so as to be in contact with the outer surface of the case wall 21, on the outer side of the case 20.

The plate part 61 is provided with a plate through-hole 62. The plate through-hole 62 is a hole that the pipe part 51 penetrates. The plate through-hole 62 is provided near the center of the body of the plate part 61. The plate through-hole 62 is formed in a shape that allows insertion and relative rotation of the pipe part 51 therein. The second joint member 60 is disposed on the outer side of the case 20 such that the plate part 61 opposes the outer surface of the case wall 21 and the pipe part 51 is inserted into the plate through-hole 62.

In a state where the flange part 52 and the plate part 61 oppose each other with the case wall 21 interposed therebetween and the pipe part 51 penetrates the case through-hole 22 in the case wall 21 and the plate through-hole 62 in the plate part 61, the first joint member 50 including the pipe part 51 and the flange part 52 and the second joint member 60 including the plate part 61 are assembled to each other, whereby the pipe joint unit 40 is mounted and fixed to the case wall 21.

The first joint member 50 and the second joint member 60 have a pipe mounting structure 80. The pipe mounting structure 80 is a structure that fastens the first joint member 50 and the second joint member 60 to the case wall 21 to fix the pipe part 51 to the case wall 21. The pipe mounting structure 80 fixes the pipe part 51 to the case wall 21 with the relative distance, in the opposing direction (i.e., the extending direction X of the pipe part 51) between the flange part 52 and the plate part 61, reduced by the first joint member 50 and the second joint member 60 performing relative rotation in a first direction (e.g., clockwise direction) of the circumferential direction of the pipe part 51, in a predetermined state.

The predetermined state is a state where: the flange part 52 and the plate part 61 oppose each other with the case wall 21 interposed therebetween in the extending direction X of the pipe part 51; the pipe part 51 and the hook part 55 are inserted in the case through-hole 22 in the case wall 21; and the pipe part 51 penetrates the plate through-hole 62 in the plate part 61.

As shown in FIG. 4, FIG. 7, FIG. 8, and FIG. 10, the pipe mounting structure 80 has a first inclined surface 81 and a second inclined surface 82. The first inclined surface 81 is an inclined surface formed at the first joint member 50. The second inclined surface 82 is an inclined surface formed at the second joint member 60. The inclined surface 81 and the inclined surface 82 are formed so as to come into contact with each other when the first joint member 50 and the second joint member 60 mutually perform relative rotation in the first direction in the predetermined state.

The first inclined surface 81 and the second inclined surface 82 are each formed so as to extend along the circumferential direction of the pipe part 51. The first inclined surface 81 and the second inclined surface 82 are each inclined such that the height position in the extending direction X changes in accordance with a circumferential position. The first inclined surface 81 and the second inclined surface 82 are configured to come close to be in contact with each other, by the first joint member 50 and the second joint member 60 mutually performing relative rotation in the first direction.

The first inclined surface 81 is inclined, in the first joint member 50, toward a direction opposite (i.e., direction toward the inside of the case 20=inward) to the disposition side of the second joint member 60 with respect to the first joint member 50 in the extending direction X. The first inclined surface 81 is provided at a protruding portion 83 protruding outward from the outer surface of the flange part 52 of the first joint member 50. The protruding portion 83 is formed in an L-shape so as to protrude outward from the flange part 52 and bend and extend in the radial direction at a leading end portion. The protruding portion 83 is provided with a first engagement surface 84. The first engagement surface 84 is a surface oriented inward without being inclined in the protruding portion 83. The first engagement surface 84 is continuously provided in the circumferential direction with respect to the inner end of the first inclined surface 81.

The second inclined surface 82 is inclined, in the second joint member 60, toward the direction opposite (i.e., direction toward the outside of the case 20=outward) to the disposition side of the first joint member 50 with respect to the second joint member 60 in the extending direction X. The second joint member 60 is provided with a second engagement surface 85. The second engagement surface 85 is a surface oriented outward without being inclined in the second joint member 60. The second engagement surface 85 is continuously provided in the circumferential direction with respect to the outer end of the second inclined surface 82.

When the first inclined surface 81 and the second inclined surface 82 have come into contact with each other through relative rotation in the first direction between the first joint member 50 and the second joint member 60, and then, the relative rotation in the first direction has advanced, the first engagement surface 84 and the second engagement surface 85 come into contact with each other to be engaged with each other. The first engagement surface 84 and the second engagement surface 85 are engaged with each other in a state of being oriented in the extending direction X.

The first joint member 50 and the second joint member 60 come close to each other in the extending direction X due to the force generated by the first inclined surface 81 and the second inclined surface 82 coming into surface contact in association with relative rotation in the first direction, and reduces the relative distance in the extending direction X between the flange part 52 and the plate part 61. Then, due to the force generated by the first engagement surface 84 and the second engagement surface 85 coming into surface contact in association with further relative rotation in the first direction, the case wall 21 is sandwiched by the flange part 52 and the plate part 61, whereby the pipe part 51 is fixed to the case wall 21.

The first joint member 50 and the second joint member 60 have a rotation stop structure 90. The rotation stop structure 90 is a structure that restricts the first joint member 50 and the second joint member 60 from performing relative rotation in a second direction reverse to the first direction of the circumferential direction of the pipe part 51 in a state where the pipe part 51 is fixed to the case wall 21 by the pipe mounting structure 80. The rotation stop structure 90 performs the above relative rotation restriction after, from the above-described predetermined state, the engagement surfaces 84, 85 have come into contact with each other through relative rotation in the first direction between the first joint member 50 and the second joint member 60, and the pipe part 51 has been fixed to the case wall 21.

The rotation stop structure 90 has a first rotation stop part 91 provided to the first joint member 50, and a second rotation stop part 92 provided to the second joint member 60. The first rotation stop part 91 opposes the second rotation stop part 92 in the extending direction X, when the pipe part 51 and the hook part 55 are inserted into the case through-hole 22 in the case wall 21 in a state where the flange part 52 and the plate part 61 oppose each other with the case wall 21 interposed therebetween in the extending direction X, and then, the first rotation stop part 91 opposes the second rotation stop part 92 in the circumferential direction (specifically, the second direction), after the engagement surfaces 84, 85 have come into contact with each other and the pipe part 51 has been fixed to the case wall 21.

The first rotation stop part 91 is the above-described protruding portion 83, is formed in a shape capable of causing the second rotation stop part 92 to undergo deflection deformation in the extending direction X, and is formed in a shape capable of coming into contact with the second rotation stop part 92 in the second direction of the circumferential direction. That is, the first rotation stop part 91 has a pressing surface that comes into contact with the second rotation stop part 92 in the extending direction X during movement in the extending direction X, and has a restriction surface capable of coming into contact with the second rotation stop part 92 in the second direction of the circumferential direction after fixation of the pipe part 51 to the case wall 21.

The second rotation stop part 92 is capable of undergoing deflection deformation in the extending direction X of the pipe part 51, in the second joint member 60. Specifically, as shown in FIG. 10, the second rotation stop part 92 is capable of undergoing deflection deformation outward in the extending direction X from an ordinary state. The second rotation stop part 92 is formed in a plate spring shape.

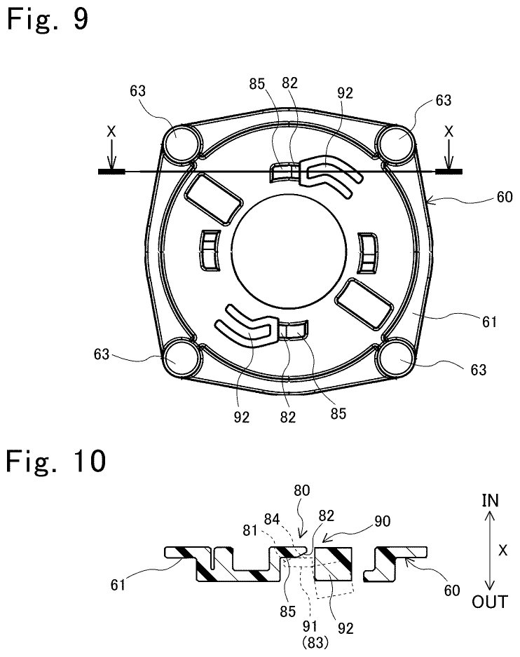

The second rotation stop part 92 may extend in either of the circumferential direction and the radial direction from the body side of the second joint member 60, as long as the second rotation stop part 92 is capable of undergoing deflection deformation in the extending direction X. However, in order to make the second joint member 60 compact while ensuring the length of the second rotation stop part 92 from the root portion connected to the body of the second joint member 60 to the leading end portion so as to easily cause deflection deformation in the extending direction X, the second rotation stop part 92 preferably extends in the circumferential direction. The second rotation stop part 92 extending in the circumferential direction may extend in a linear shape in the circumferential direction, but may extend while being curved along the circumferential direction as shown in FIG. 9.

The second rotation stop part 92 undergoes deflection deformation by being pressed outwardly in the extending direction X by the first rotation stop part 91 when the first joint member 50 and the second joint member 60 have been moved so as to come close to each other in the extending direction X in a state where the flange part 52 and the plate part 61 oppose each other with the case wall 21 interposed therebetween in the extending direction X and the pipe part 51 and the hook part 55 are inserted in the case through-hole 22 in the case wall 21 and the plate through-hole 62 in the plate part 61.

Before the second rotation stop part 92 is pressed by the first rotation stop part 91, the second inclined surface 82 has not reached a position in the extending direction X where the second inclined surface 82 is capable of coming into contact with the first inclined surface 81, and even if the first joint member 50 and the second joint member 60 perform relative rotation in the first direction, the first inclined surface 81 and the second inclined surface 82 do not come into contact with each other. On the other hand, when the second rotation stop part 92 has undergone deflection deformation by being pressed outwardly in the extending direction X by the first rotation stop part 91, the second inclined surface 82 is capable of reaching a position in the extending direction X where the second inclined surface 82 is capable of coming into contact with the first inclined surface 81, and then, after the reaching, when the first joint member 50 and the second joint member 60 perform relative rotation in the first direction, the first inclined surface 81 and the second inclined surface 82 come into contact with each other.

During the process in which the relative rotation in the first direction between the first joint member 50 and the second joint member 60 advances, the pressing from the first rotation stop part 91 is released and the above-described deflection deformation is released, whereby the second rotation stop part 92 returns to the original position. After the second rotation stop part 92 has returned to the original position, the first rotation stop part 91 and the second rotation stop part 92 oppose each other in the second direction of the circumferential direction, and relative rotation in the second direction between the first joint member 50 and the second joint member 60 is restricted.

The seal member 70 is a member that seals the space between the case wall 21 and the flange part 52 on the outer periphery side of the pipe part 51. The seal member 70 is formed such that the portion (i.e., the flow-in part 53 side), of the pipe part 51, to be inserted into the case wall 21 is insertable. The seal member 70 is disposed so as to surround the outer periphery on the flow-in part 53 side of the pipe part 51. The seal member 70 is, for example, a gasket formed in an annular shape. The seal member 70 is made of resin, for example. The pipe joint unit 40 may include a seal member in an annular shape that seals the space between the case wall 21 and the plate part 61 on the outer periphery side of the pipe part 51, together with the seal member 70 that seals the space between the flange part 52 and the case wall 21, or instead of the seal member 70.

The second joint member 60 has a handle part 63. The handle part 63 is a portion that assists the mounting and fixing work of the pipe joint unit 40 to the case wall 21, i.e., the assembling work (specifically, movement work into the extending direction X, and rotation work into the circumferential direction) of the second joint member 60 to the first joint member 50. The handle part 63 is formed in a shape that facilitates the above-described assembling work performed by a worker, and for example, is formed so as to protrude outwardly from the outer surface of the plate part 61. The handle part 63 is disposed at a peripheral edge portion that is far (especially, the farthest peripheral edge portion is preferable) from the rotation center in the plate part 61, for example, and is provided at a plurality of places (four places in FIG. 4, etc.) at the peripheral edge portion.

Mounting and fixing of the pipe joint unit 40 (specifically, the inlet-side pipe unit 40A) to the case wall 21 are performed in the following procedure.

First, the pipe part 51 of the first joint member 50 is inserted into the seal member 70, the resultant first joint member 50 is disposed in the case 20, and the flow-in part 53 side of the pipe part 51 and the hook part 55 are inserted into the case through-hole 22 in the case wall 21 so as to protrude from the inner side to the outer side of the case wall 21. At this time, the first joint member 50 is positioned with respect to the case wall 21, and the seal member 70 is present between the flange part 52 of the first joint member 50 and the case wall 21.

Next, on the outer side of the case 20, the second joint member 60 is moved inwardly in the extending direction X such that: the plate part 61 opposes the flange part 52 with the case wall 21 interposed therebetween in the extending direction X; and the leading end portion of the pipe part 51 is inserted into the plate through-hole 62 in the plate part 61. Then, when the movement of the second joint member 60 has advanced, the second rotation stop part 92 of the second joint member 60 is pressed by the first rotation stop part 91 of the first joint member 50, and undergoes deflection deformation outwardly in the extending direction X.

In a state where the second rotation stop part 92 has undergone deflection deformation as above, the second joint member 60 is rotated in the first direction with respect to the first joint member 50. When the second joint member 60 has been rotated in the first direction with respect to the first joint member 50, the first inclined surface 81 and the second inclined surface 82 come into contact with each other. When the rotation in the first direction further advances after such contact has occurred, the inclined surfaces 81, 82, while being in contact with each other, are shifted in position in the extending direction X in association with the rotation in the first direction, and the second joint member 60 comes close to the first joint member 50 in the extending direction X.

When the state where the inclined surfaces 81, 82 are in contact with each other has shifted to a state where the engagement surfaces 84, 85 are in contact with each other, the first joint member 50 and the second joint member 60 come closest to each other in the extending direction X, and the relative distance in the extending direction X between the flange part 52 and the plate part 61 is reduced. The deflection deformation of the second rotation stop part 92 is released during the process in which the relative rotation in the first direction between the first joint member 50 and the second joint member 60 advances.

When the first joint member 50 and the second joint member 60 come closest to each other in the extending direction X, and the relative distance in the extending direction X between the flange part 52 and the plate part 61 is reduced, the force with which the flange part 52 and the plate part 61 sandwich the case wall 21 increases, and the pipe part 51 is fixed to the case wall 21. In this case, the seal member 70 is present between the flange part 52 and the case wall 21.

Generally, the mounting and fixing work of the pipe joint unit 40 to the case wall 21 performed by worker, i.e., the work of moving, performed by the worker, the second joint member 60 inwardly in the extending direction X with respect to the first joint member 50, and the work of rotating, performed by the worker, the second joint member 60 toward the first direction of the circumferential direction of the pipe part 51 with respect to the first joint member 50 are each performed by the worker holding the handle part 63 of the second joint member 60 with a hand.

Thus, in the pipe joint unit 40, the flange part 52 and the plate part 61 are disposed so as to oppose each other with the case wall 21 interposed therebetween, and then, the first joint member 50 and the second joint member 60 are caused to perform relative rotation in the first direction of the circumferential direction of the pipe part 51 to be assembled with each other, whereby the relative distance in the extending direction X between the flange part 52 and the plate part 61 is reduced. As a result, the pipe part 51 is fixed to the case wall 21.

Specifically, first, the first joint member 50 and the second joint member 60 are moved so as to come close to each other in the extending direction X of the pipe part 51, and the second rotation stop part 92 is caused to undergo deflection deformation by the first rotation stop part 91. Next, in the deflection deformation state, the first joint member 50 and the second joint member 60 are caused to perform relative rotation in the first direction of the circumferential direction of the pipe part 51, thereby causing surface contact between the first inclined surface 81 and the second inclined surface 82. Then, the relative rotation is caused to advance, to cause the inclined surfaces 81, 82 to be shifted in the position in the extending direction X, and eventually, the first engagement surface 84 and the second engagement surface 85 are caused to be engaged with each other. Accordingly, the first joint member 50 and the second joint member 60 are assembled to each other, whereby the pipe part 51 is fixed to the case wall 21.

In such a configuration, mounting and fixing of the pipe joint unit 40 to the case wall 21 do not require preparation of a plurality of bolts and bolt holes corresponding to the bolts. Therefore, preparation of the first joint member 50 and the second joint member 60 is sufficient for performing the above-described mounting and fixing. Therefore, mounting and fixing of the pipe joint unit 40 to the case wall 21 are realized in a simple manner and at low cost. Since performing the above-described mounting and fixing does not require insertion and fastening of each bolt into a corresponding bolt hole, assembling man-hour is reduced.

When the pipe joint unit 40 is mounted and fixed to the case wall 21, the seal member 70 in an annular shape is present between the flange part 52 of the first joint member 50 and the case wall 21. Therefore, the sealing performance around the case through-hole 22 in the case wall 21 is ensured, and entry of water from outside of the case 20 into the case 20, and liquid leakage from the inside of the case 20 to the outside of the case 20 are prevented.

In the pipe joint unit 40, in a state where the pipe part 51 is fixed to the case wall 21 by the pipe mounting structure 80, relative rotation in the second direction between the first joint member 50 and the second joint member 60 is restricted by the rotation stop structure 90.

Specifically, in the rotation stop structure 90, due to movement in which the first joint member 50 and the second joint member 60 come close to each other in the extending direction X, the first rotation stop part 91 is pressed against the second rotation stop part 92, to cause the second rotation stop part 92 to undergo deflection deformation from the ordinary state, and then, the first rotation stop part 91 is moved in the circumferential direction through relative rotation in the first direction between the first joint member 50 and the second joint member 60, to release the deflection deformation of the second rotation stop part 92 and return the second rotation stop part 92 to the ordinary state.

When the second rotation stop part 92 undergoes deflection deformation from the ordinary state, then, the first rotation stop part 91 moves in the first direction from the contact state with the second rotation stop part 92, and then the second rotation stop part 92 returns to the ordinary state as described above, the first rotation stop part 91 and the second rotation stop part 92 oppose each other and come into contact with each other in the second direction of the circumferential direction. Accordingly, relative rotation in the second direction between the first joint member 50 and the second joint member 60 is restricted.

Therefore, in a state where the pipe part 51 is fixed to the case wall 21 by the pipe mounting structure 80, relative rotation between the first joint member 50 and the second joint member 60 in the second direction in which contact between the inclined surfaces 81, 82 or engagement between the engagement surfaces 84, 85 is released, is prevented. Therefore, after fixation of the pipe part 51 to the case wall 21, release of assembly between the first joint member 50 and the second joint member 60 is prevented, unnecessary dismount of the pipe part 51 from the case wall 21 is prevented, and reliability of the pipe joint unit 40 is improved.

Further, the mounting and fixing of the pipe joint unit 40 to the case wall 21 are realized by the work of moving, performed by the worker holding the handle part 63 of the second joint member 60 with a hand, the second joint member 60 inwardly in the extending direction X with respect to the first joint member 50, or the work of rotating, performed by the worker, the second joint member 60 toward the first direction of the circumferential direction of the pipe part 51 with respect to the first joint member 50. Therefore, workability of the mounting and fixing work of the pipe joint unit 40 to the case wall 21 performed by the worker is improved.

In the above embodiment, when the pipe joint unit 40 is to be mounted and fixed to the case wall 21, first, the first joint member 50 is disposed in the case 20, and then, the second joint member 60 is assembled to the first joint member 50. However, the present disclosure is not limited thereto. When the pipe joint unit 40 is to be mounted and fixed to the case wall 21, first, the second joint member 60 may be disposed outside the case 20, and then, the first joint member 50 may be assembled to the second joint member 60 with the case wall 21 interposed therebetween.

In a modification of the above, a handle part that assists the assembling work of the second joint member 60 to the first joint member 50 may be provided to the first joint member 50, instead of the second joint member 60.

In the above embodiment, the rotation stop structure 90 has the first rotation stop part 91 being the protruding portion 83 provided to the first joint member 50, and the second rotation stop part 92 provided to the second joint member 60 and capable of undergoing deflection deformation. However, the present disclosure is not limited thereto. Conversely, a rotation stop structure may have a first rotation stop part provided to the first joint member 50 and capable of undergoing deflection deformation, and a second rotation stop part being a protruding portion provided to the second joint member 60.

The present disclosure is not limited to the embodiment and the like described above. Various changes may be made without departing from the gist of the present disclosure, including selecting and combining as appropriate elements described in the embodiment and the like to carry out the present disclosure. In addition, the specification of the present disclosure discloses not only the technical concept indicated in the citation relationship between the claims as originally filed, but also the technical concept obtained by combining the matters recited in the claims as appropriate.

This application claims priority on Japanese Patent Application No. 2024-047371 filed on Mar. 22, 2024, the entire contents of which are incorporated herein by reference.

1. A pipe joint unit comprising:
a first joint member having a pipe part in a tubular shape extending through a case through-hole provided in a case wall, and a flange part integrated with the pipe part and extending radially outward at a position in an extending direction of the pipe part; and
a second joint member having a plate part in a plate shape, the plate part being provided with a plate through-hole that the pipe part penetrates and opposing the flange part with the case wall interposed therebetween, the second joint member being capable of performing relative rotation with respect to the first joint member, wherein
the first joint member and the second joint member have a pipe mounting structure configured to fix the pipe part to the case wall with a relative distance, in the extending direction between the flange part and the plate part, reduced by the first joint member and the second joint member performing relative rotation in a first direction of a circumferential direction of the pipe part in a state where the flange part and the plate part oppose each other with the case wall interposed therebetween in the extending direction.

2. The pipe joint unit according to claim 1, wherein
the pipe mounting structure has:
a first inclined surface formed at the first joint member so as to extend along the circumferential direction, and having a height position, in the extending direction, that changes in accordance with a circumferential position; and
a second inclined surface formed at the second joint member so as to extend along the circumferential direction, and having a height position, in the extending direction, that changes in accordance with a circumferential position, the second inclined surface being configured to come close to be in contact with the first inclined surface through relative rotation in the first direction between the first joint member and the second joint member.

3. The pipe joint unit according to claim 2, wherein
the first inclined surface is inclined, in the first joint member, toward a direction opposite to a disposition side of the second joint member with respect to the first joint member in the extending direction, and
the second inclined surface is inclined, in the second joint member, toward a direction opposite to a disposition side of the first joint member with respect to the second joint member in the extending direction.

4. The pipe joint unit according to claim 1, wherein
the first joint member and the second joint member have a rotation stop structure configured to restrict the first joint member and the second joint member from performing relative rotation in a second direction reverse to the first direction of the circumferential direction in a state where the pipe part is fixed to the case wall by the pipe mounting structure.

5. The pipe joint unit according to claim 1, comprising
a seal member, in an annular shape, configured to seal a space between the case wall and the flange part or the plate part on an outer periphery side of the pipe part.

6. The pipe joint unit according to claim 1, wherein
the second joint member has a handle part configured to assist assembling work of the second joint member to the first joint member.
